(19) United States
(12) Patent Application Publication
(10) Pub. No.: US 2015/0048115 A1
(43) Pub. Date: Feb. 19, 2015

(54) CAULKING GUN HAVING CHANGEABLE CARTRIDGE

(71) Applicant: Siang Syuan Fu Industry Co., Ltd., Changhua (TW)

(72) Inventor: Hung Chih HUNG, Changhua (TW)

(73) Assignee: Siang Syuan Fu Industry Co., Ltd., Changhua (TW)

(21) Appl. No.: 13/965,247

(22) Filed: Aug. 13, 2013

(51) Int. Cl. B05C 17/005; B05C 17/01

(52) U.S. Cl. CPC B05C 17/00596; B05C 17/0116
USPC 222/143; 222/326

(57) ABSTRACT

A caulking gun includes a housing having a channel opened upwardly, a supporting bracket engageable into the channel of the housing and having an opening for detachably attaching a cartridge member, and a latch device having a latch member slidably attached to the housing and movable relative to the housing for selectively engaging with the supporting bracket and for preventing the supporting bracket and the cartridge member from being disengaged from the housing. The latch member includes two anchors engageable into the channel of the housing for engaging with the supporting bracket and for preventing the supporting bracket and the cartridge member from being disengaged from the housing.

### BACKGROUND OF THE INVENTION

1. Field of the Invention

The present invention relates to a caulking gun or fluid dispensing gun, and more particularly to a caulking gun or fluid dispensing gun including an improved structure or configuration for allowing the dispensing cartridge package to be easily and quickly replaced or changed with the new ones of different sizes or shapes or volumes or standards with the same caulking gun or fluid dispensing gun.

2. Description of the Prior Art

Various kinds of typical caulking guns or fluid dispensing guns have been developed and provided for receiving or engaging with the dispensing cartridges or packages and for depressing or squeezing or operating the dispensing cartridges or packages to release or dispense the fluid or liquid contained in the dispensing cartridges or packages.

For example, U.S. Pat. No. 5,058,769 to Kurtz, U.S. Pat. No. 5,156,305 to Eyre, U.S. Pat. No. 5,381,931 to Chang, U.S. Pat. No. 5,887,765 to Broesamle, U.S. Pat. No. 6,123,235 to Hsu, U.S. Pat. No. 6,691,899 to Sung, U.S. Pat. No. 7,011,238 to Sung, and U.S. Pat. No. 7,637,398 to Sung disclose several of the typical caulking guns or fluid dispensing guns each comprising a component supporting bracket for receiving or engaging with or for supporting a fluid or liquid dispensing cartridge or package and for dispensing the fluid or liquid contained in the dispensing cartridge or package.

However, the component supporting bracket may only be used for receiving or engaging with or for supporting a single fluid or liquid dispensing cartridge or package, but may not be used for receiving or engaging with or for supporting dual component dispensing cartridges or packages.

U.S. Pat. No. 5,064,098 to Hutter, III, et al., and U.S. Pat. No. 5,104,005 to Schneider, Jr. et al. disclose the other typical caulking guns or fluid dispensing guns each also comprising a component supporting bracket for receiving or engaging with or for supporting a dual dispensing cartridge or package and for dispensing the fluid or liquid contained in the dual dispensing cartridge or package.

However, the dual dispensing cartridge or package may not be easily and quickly replaced or changed with the new ones, in addition, the typical caulking guns or fluid dispensing guns may not be used for receiving or engaging with the other dispensing cartridges or packages of different sizes or shapes or volumes or standards.

The present invention has arisen to mitigate and/or obviate the afore-described disadvantages of the conventional caulking guns or fluid dispensing guns.

### SUMMARY OF THE INVENTION

The primary objective of the present invention is to provide a caulking gun or fluid dispensing gun including an improved structure or configuration for allowing the dispensing cartridge package to be easily and quickly replaced or changed with the new ones of different sizes or shapes or volumes or standards with the same caulking gun or fluid dispensing gun.

In accordance with one aspect of the invention, there is provided a caulking gun comprising a housing including a gun handle extended therefrom for being grasped by a user, and including a trigger pivotally attached to the housing, and including a channel formed in a front portion of the housing and opened upwardly, a supporting bracket engageable into the channel of the housing and including an opening formed therein, a cartridge member engageable into the opening of the supporting bracket and detachably attached to the supporting bracket, and a latch device including a latch member slidably attached to the housing and movable relative to the housing for selectively engaging with the supporting bracket and for preventing the supporting bracket and the cartridge member from being disengaged or detached from the housing.

The housing includes a passage formed in the upper portion thereof for slidably receiving and engaging with the latch member. The latch member includes two anchors extended therefrom and engageable into the channel of the housing for selectively engaging with the supporting bracket and for preventing the supporting bracket and the cartridge member from being disengaged from the housing.

The latch member includes a space formed between the anchors for slidably receiving and engaging with the supporting bracket and for allowing the supporting bracket to be selectively engaged through the space of the latch member and to be selectively moved into and out of the housing.

The supporting bracket includes two projections extended outwardly therefrom for selectively engaging with the anchors of the latch member and for limiting the supporting bracket to slide or move relative to the housing and for preventing the supporting bracket and the cartridge member from being disengaged from the housing.

The housing includes a compartment formed therein and communicating with the channel of the housing for selectively receiving and engaging with the projections of the supporting bracket and for allowing the supporting bracket to be tilted or inclined relative to the housing. The latch device includes a spring biasing member engaged with the latch member for biasing and forcing the anchors of the latch member engage into the channel of the housing.

The cartridge member includes a panel provided thereon for engaging with the supporting bracket and for anchoring the supporting bracket to the cartridge member. The cartridge member includes two casings for receiving a fluid to be dispensed. The casings of the cartridge member include a shape identical to each other or different from each other for engaging with the opening of the supporting bracket that includes the shape identical to the casings of the cartridge member.

The housing includes a driving device having two ram rods slidably engaged in the housing and slidably engaged into the casings of the cartridge member for selectively dispensing the fluid contained in the casings of the cartridge member. The driving device includes a transfer block, the ram rods are attached to the transfer block and parallel to each other.

A spare or additional or secondary supporting bracket may further be provided and changeably engageable into the channel of the housing and includes an opening formed in the spare supporting bracket, and a spare cartridge member is engageable into the opening of the spare supporting bracket and detachably attached or mounted to the spare supporting bracket for detachably attaching to the housing.

The spare cartridge member includes a panel provided thereon for engaging with the spare supporting bracket and for anchoring or retaining the spare supporting bracket to the spare cartridge member. The spare cartridge member includes two casings for receiving a fluid to be dispensed. The casings of the spare cartridge member include a shape identical to each other or different from each other for engaging with the opening of the supporting bracket that includes the shape identical to the casings of the cartridge member.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a caulking gun or fluid dispensing gun in accordance with the present invention;

FIG. 2 is a perspective view of the caulking gun or fluid dispensing gun;

FIG. 3 is a top plan schematic view of the caulking gun or fluid dispensing gun;

FIG. 4 is a side plan schematic view of the caulking gun or fluid dispensing gun, in which a portion of the caulking gun or fluid dispensing gun has been cut off for showing the inner structure of the caulking gun or fluid dispensing gun;

FIG. 5 is an enlarged partial cross sectional view of the caulking gun or fluid dispensing gun;

FIG. 6 is another top plan schematic view similar to FIG. 3, illustrating the operation of the caulking gun or fluid dispensing gun;

FIG. 7 is another side plan schematic view similar to FIG. 4, illustrating the operation of the caulking gun or fluid dispensing gun;

FIG. 8 is an enlarged partial cross sectional view similar to FIG. 5, illustrating the operation of the caulking gun or fluid dispensing gun; and

FIGS. 9, 10 are other side plan schematic views similar to FIGS. 4 and 7, illustrating the operation of the caulking gun or fluid dispensing gun.

### DETAILED DESCRIPTION OF THE PREFERRED EMBODIMENT

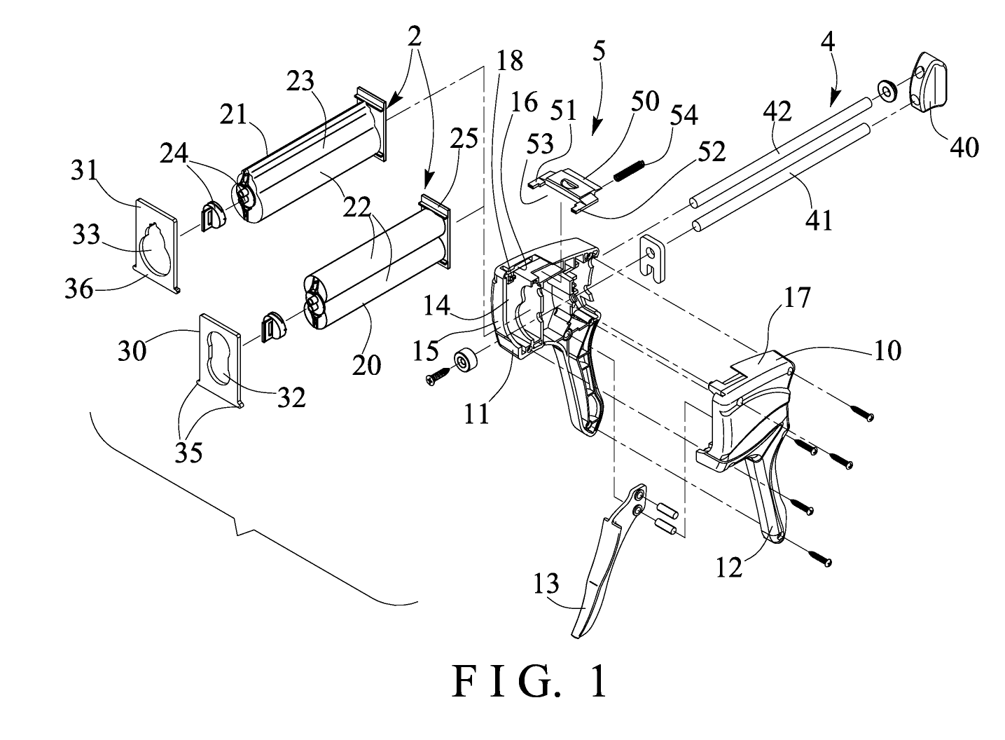

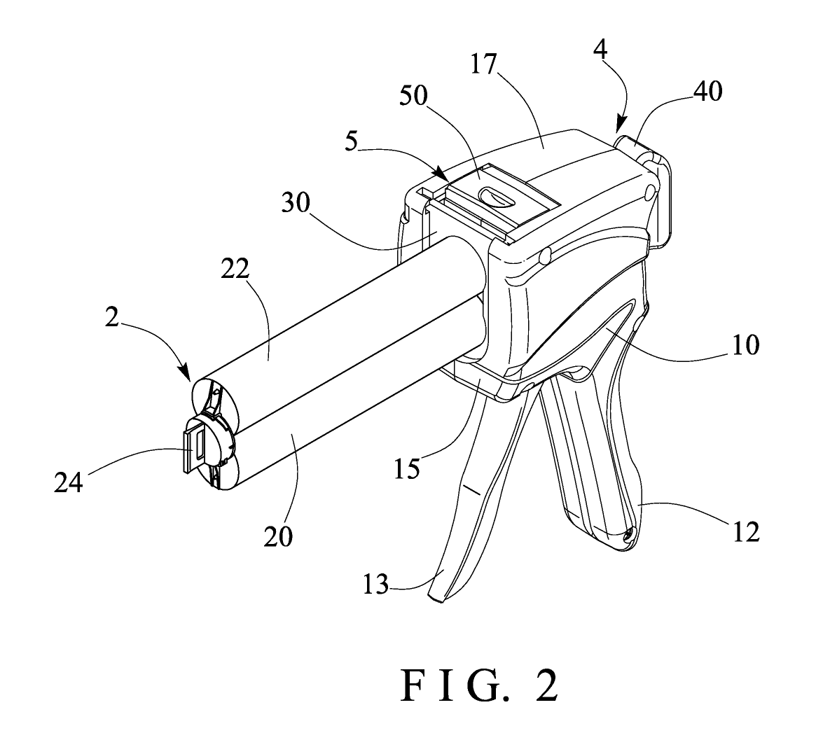

Referring to the drawings, and initially to FIGS. 1-4, a caulking gun or fluid dispensing gun in accordance with the present invention comprises a gun body or receptacle or housing 10 including one or more (such as two) housing members 11 to be mounted or secured or coupled together with latches or fasteners or the like (not illustrated), and including a gun handle 12 extended downwardly therefrom for being gripped or grasped or held by the user, and including a trigger 13 pivotally or rotatably attached or mounted or secured to the housing 10 for actuating or operating the caulking gun, in which the gun handle 12 and the trigger 13 are typical and are not related to the present invention and will not be described in further details.

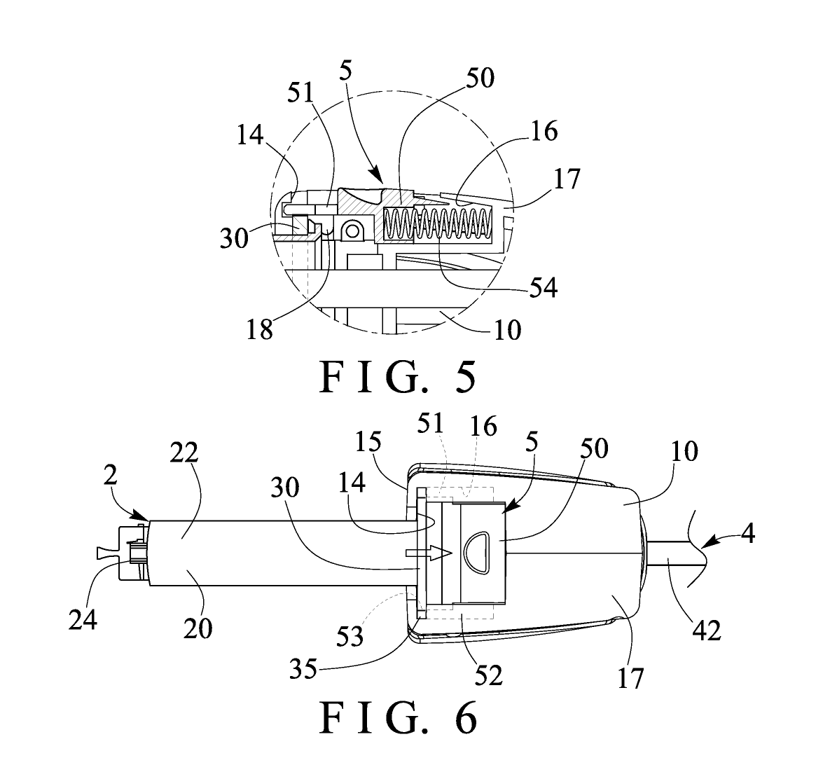

The housing 10 further includes a groove or slot or channel 14 formed or provided in the front portion 15 thereof and directed or opened upwardly for slidably receiving or engaging with or replacing or changing or inserting or disengaging a dispensing cartridge package 2, and includes a channel or slot or groove or passage 16 formed or provided in the upper portion 17 thereof and substantially perpendicular to the channel 14 of the housing 10 and intersecting or communicating with the channel 14 of the housing 10, and includes a relatively decreased or reduced space or chamber or compartment 18 formed therein, such as formed in the front portion 15 and the upper portion 17 thereof and located between and communicating with the channel 14 and the passage 16 of the housing 10 (FIGS. 1, 5, 8).

The dispensing cartridge package 2 includes a number of cartridge members 20, 21 (FIG. 1) each having one or more (such as two) casings 22, 23 for receiving or containing or engaging with the fluid or liquid to be released or dispensed, and the cartridge members 20, 21 each include an ejection nozzle 24 for directing or guiding the fluid or liquid to flow out of the casings 22, 23. For example, the casings 22 of the cartridge member 20 include the same size or shape or volume or standard, but the casings 22, 23 of the other cartridge member 21 may include different sizes or shapes or volumes or standards, and the cartridge members 20, 21 each include an end panel 25 formed or provided at one end portion thereof and substantially perpendicular to the casings 22, 23 for solidly and stably anchoring or retaining or positioning the casings 22, 23 together.

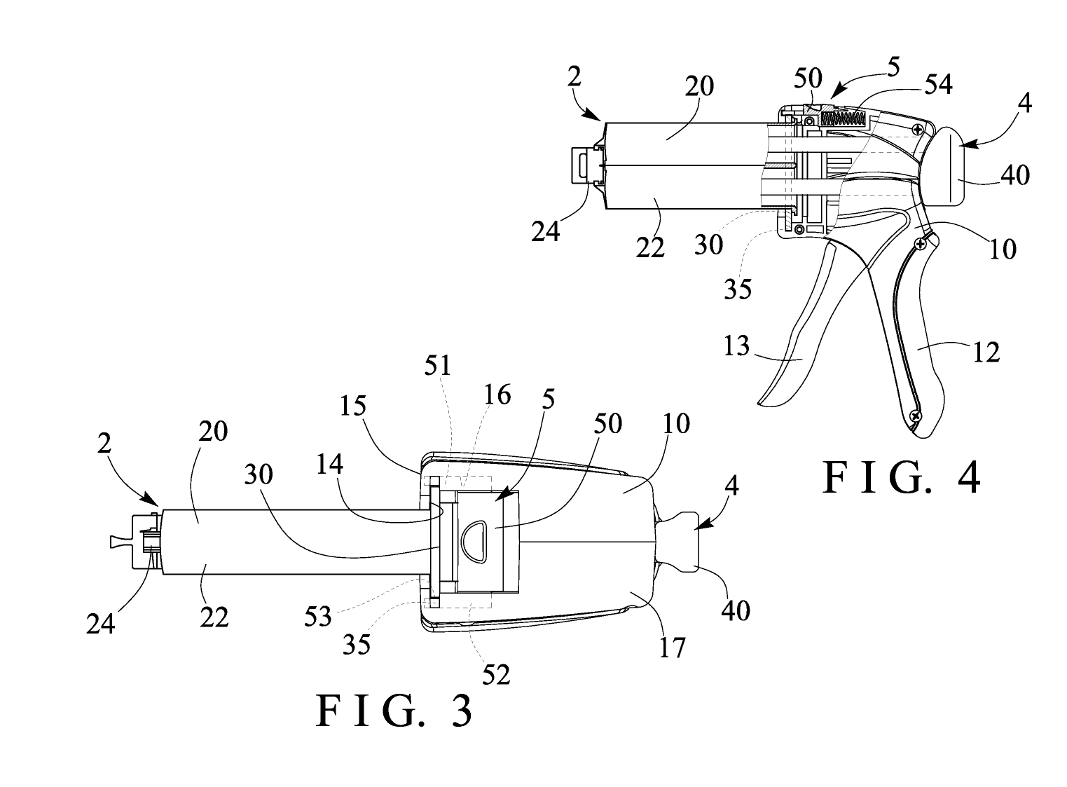

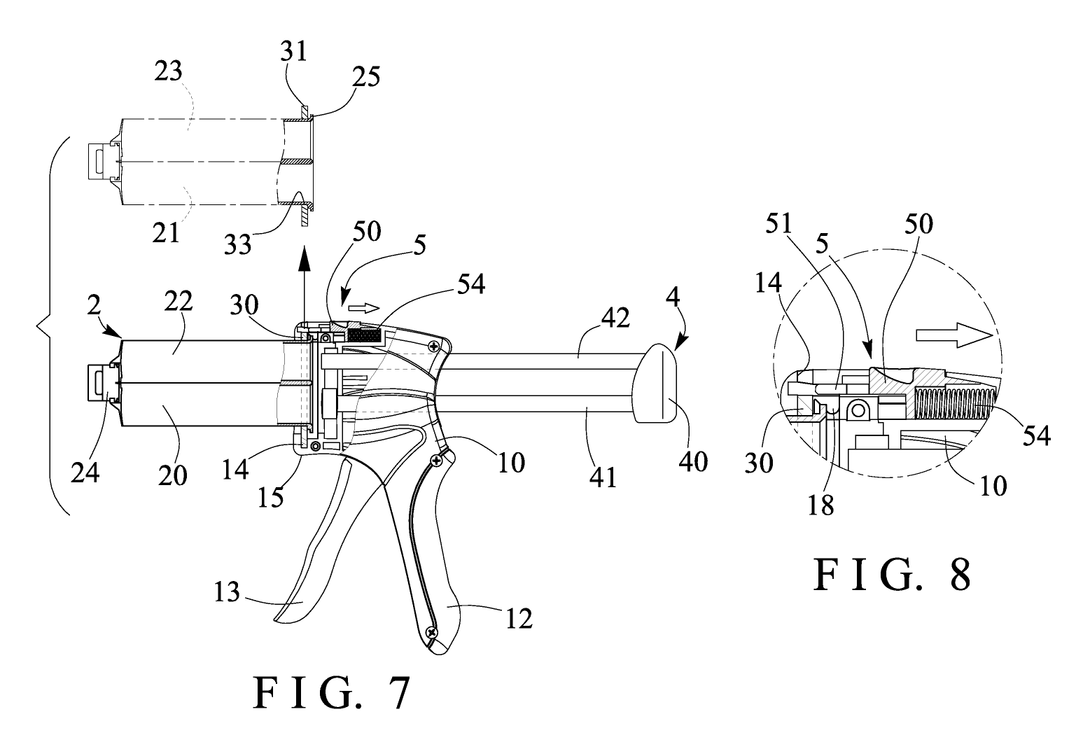

The dispensing cartridge package 2 further includes a number of retainers or carriers or supporting brackets 30, 31 for engaging with the cartridge members 20, 21 respectively, for example, the supporting brackets 30, 31 each include a space or compartment or chamber or opening 32, 33 formed therein and having a size or shape or standard similar to or identical to that of the casings 22, 23 for selectively receiving or engaging with the casings 22, 23 and for allowing the supporting brackets 30, 31 to be fitted or attached or mounted or engaged onto the casings 22, 23 of the cartridge members 20, 21 respectively and to be contacted or engaged with the panels 25 of the cartridge members 20, 21 respectively and for slidably and selectively receiving or engaging into the channel 14 of the housing 10, and thus for removably or detachably attaching or mounting or securing or engaging the cartridge members 20, 21 to the housing 10 (FIGS. 3-4, 6-7, 9).

For example, the opening 32 of the supporting bracket 30 includes a size or shape or standard similar to or identical to that of the casings 22 of the cartridge member 20 which include the same size or shape or volume or standard for allowing the supporting bracket 30 to be snugly and firmly or solidly fitted or attached or mounted or engaged onto the casings 22 of the cartridge member 20, but the opening 33 of the other or spare supporting bracket 31 includes a size or shape or standard similar to or identical to that of the casings 22, 23 which include the sizes or shapes or volumes or standards different from each other for allowing the other or spare supporting bracket 31 to be snugly and firmly or solidly fitted or attached or mounted or engaged onto the different casings 22, 23 of the other or spare cartridge member 21.

The caulking gun or fluid dispensing gun in accordance with the present invention further comprises a plunger or driving device 4 including a carrier or transfer block 40, and one or more (such as two) ram rods 41, 42 attached or mounted or secured to the transfer block 40 and substantially parallel to each other and slidably received or engaged in the housing 10, and the ram rods 41, 42 are also slidably received or engaged into the casings 22, 23 of the cartridge members 20, 21 respectively and to be actuated or operated by the trigger 13 for selectively squeezing or releasing or dispensing the fluid or liquid contained in the casings 22, 23 of the dispensing cartridge members 20, 21. The actuation or operation of the ram rods 41, 42 of the transfer block 40 to the cartridge members 20, 21 is not related to the present invention and will not be described in further details.

The caulking gun or fluid dispensing gun in accordance with the present invention further comprises a lock or catch or latch device 5 including a lock or catch or latch member 50 slidably received or engaged in the passage 16 of the housing 10 and movable or slidable forwardly and rearwardly relative to the housing 10, or toward or away from the supporting brackets 30, 31 or the channel 14 at the front portion 15 of the housing 10, and the latch member 50 includes two legs or extensions or protrusions or stops or pawls or fingers or anchors 51, 52 extended forwardly therefrom and movable or slidable or extendible or engageable into the channel 14 of the housing 10 (FIGS. 3-5) for selectively engaging with the supporting brackets 30, 31 and for preventing the supporting brackets 30, 31 and the cartridge members 20, 21 from being disengaged or separated from the housing 10, and includes a notch or gap or space 53 formed or defined between the anchors 51, 52 (FIG. 1).

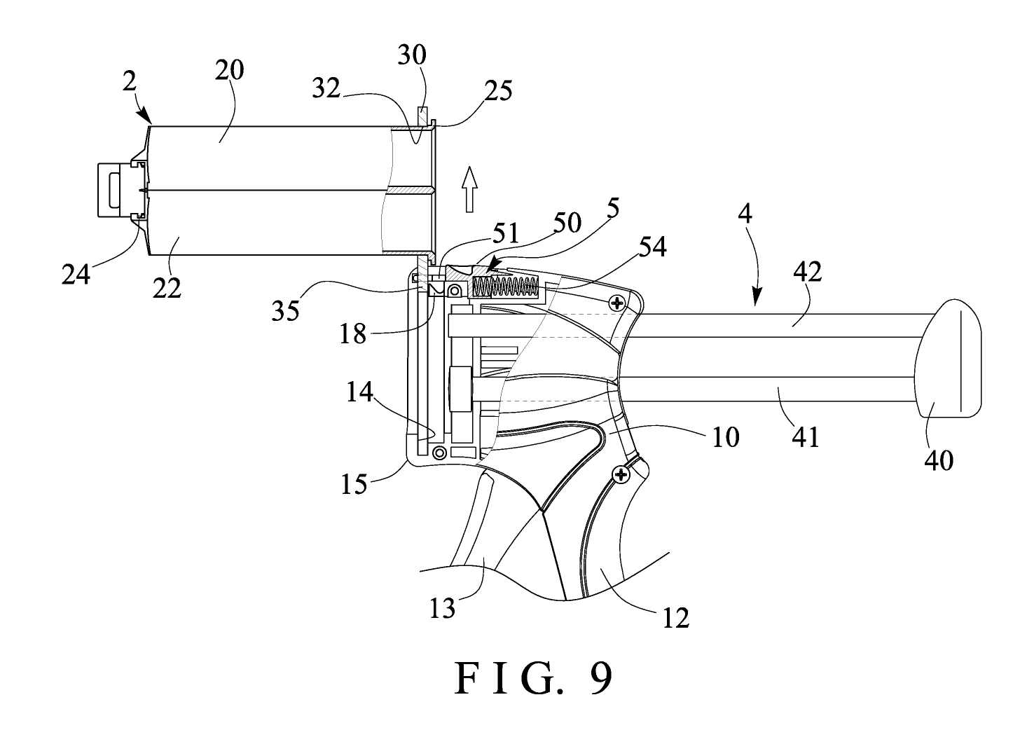

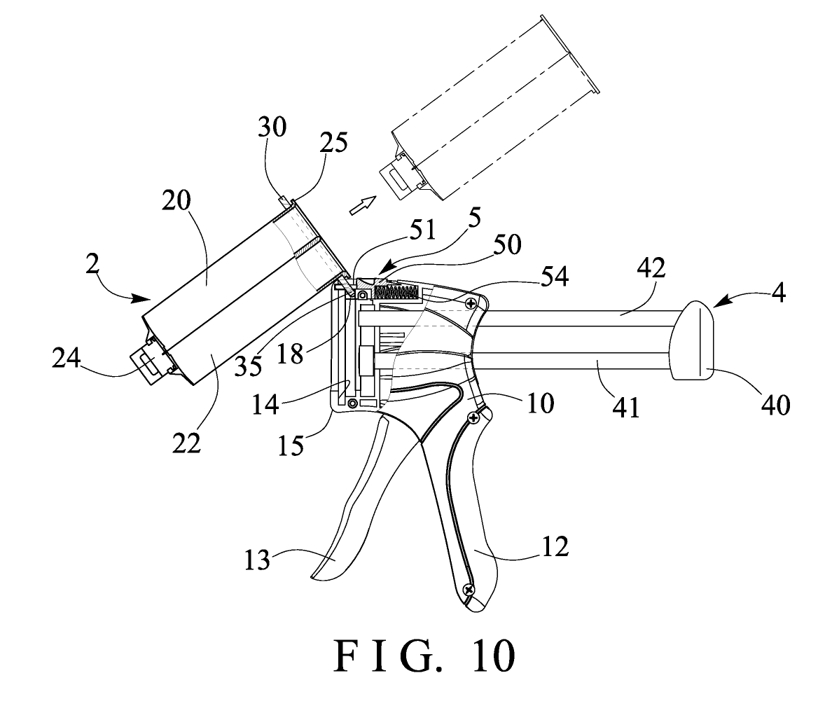

For example, the size or dimension or space or distance between the anchors 51, 52, or the size or length or width of the space 53 of the latch member 50 is equal to or slightly greater than the width of the supporting brackets 30, 31 for allowing the supporting brackets 30, 31 to be selectively moved or engaged through the space 53 of the latch member 50 and to be selectively moved into or out of the housing 10 (FIG. 9), and the supporting brackets 30, 31 each include one or more (such as two) extensions or protrusions or stops or projections 35 extended radially and outwardly therefrom, such as extended radially and outwardly from the lower or bottom portion 36 thereof (FIG. 1) for selectively engaging with the anchors 51, 52 of the latch member 50 (FIGS. 9, 10) and for limiting the supporting brackets 30, 31 to slide or move relative to the housing 10 and for preventing the supporting brackets 30, 31 and the cartridge members 20, 21 from being disengaged or separated from the housing 10.

In operation, as shown in FIGS. 3-5, the supporting bracket 30, 31 may be solidly and stably anchored or retained or positioned or supported in the channel 14 of the housing 10 by weight in order to solidly and stably anchor or retain or position or support the cartridge member 20, 21 on the housing 10. At this moment, the anchors 51, 52 of the latch member 50 may be biased and forced to engage into the channel 14 of the housing 10 with a spring biasing member 54 which is engaged between the latch member 50 and the housing 10. In addition, at this moment, the supporting bracket 30, 31 may be moved or slid or extended or engaged through the space 53 of the latch member 50 and may be selectively moved into or out of the housing 10 (FIGS. 9, 10), but the anchors 51, 52 of the latch member 50 may be contacted or engaged with the projections 35 of the supporting bracket 30, 31 for limiting the supporting bracket 30, 31 to slide or move relative to the housing 10 and for preventing the supporting bracket 30, 31 and the cartridge member 20, 21 from being disengaged or separated from the housing 10.

At this moment, as shown in FIGS. 9-10, the projections 35 of the supporting bracket 30 are movable or slidable or extendible or engageable into the compartment 18 that is formed in the front portion 15 and the upper portion 17 of the housing 10 and located between and communicating with the channel 14 and the passage 16 of the housing 10 (FIG. 10) for allowing the supporting bracket 30 to be slightly tilted or inclined relative to the housing 10, and thus for allowing the cartridge member 20 to be easily and quickly fitted or attached or mounted or engaged into or removed or disengaged or separated from the supporting bracket 30, and thus for allowing the cartridge member 20 to be easily and quickly replaced or changed with the new and the same or the identical cartridge member 20 that includes the same or identical size or shape or volume or standard or the like.

As shown in FIGS. 6-8, when the latch member 50 is moved rearwardly relative to the housing 10 and moved away from the cartridge member 20 and moved toward the spring biasing member 54 in order to depress or compress the spring biasing member 54, the anchors 51, 52 of the latch member 50 may be moved away from and removed or disengaged or separated from the supporting bracket 30 and the channel 14 of the housing 10 and may also be moved and disengaged or separated from the projections 35 of the supporting bracket 30 for allowing the supporting bracket 30 to be easily and quickly removed or disengaged or separated from the housing 10 and thus for allowing the supporting bracket 30 and the cartridge member 20 to be easily and quickly and readily replaced or changed with the new or different supporting bracket 31 and cartridge member 21.

Accordingly, the caulking gun or fluid dispensing gun in accordance with the present invention includes an improved structure or configuration for allowing the dispensing cartridge package to be easily and quickly replaced or changed with the new ones of different sizes or shapes or volumes or standards with the same caulking gun or fluid dispensing gun.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A caulking gun comprising:
a housing including a gun handle extended therefrom for being grasped by a user, and including a trigger pivotally attached to said housing, and including a channel formed in a front portion of said housing and opened upwardly,
a supporting bracket engageable into said channel of said housing and including an opening formed therein,
a cartridge member engageable into said opening of said supporting bracket and detachably attached to said supporting bracket, and
a latch device including a latch member slidably attached to said housing and movable relative to said housing for selectively engaging with said supporting bracket and for preventing said supporting bracket and said cartridge member from being disengaged from said housing.

2. The caulking gun as claimed in claim 1, wherein said housing includes a passage formed therein for slidably receiving and engaging with said latch member.

3. The caulking gun as claimed in claim 1, wherein said latch member includes two anchors extended therefrom and engageable into said channel of said housing for selectively engaging with said supporting bracket and for preventing said supporting bracket and said cartridge member from being disengaged from said housing.

4. The caulking gun as claimed in claim 3, wherein said latch member includes a space formed between said anchors for slidably receiving and engaging with said supporting bracket and for allowing said supporting bracket to be selectively engaged through said space of said latch member and to be selectively moved into and out of said housing.

5. The caulking gun as claimed in claim 4, wherein said supporting bracket includes two projections extended outwardly therefrom for selectively engaging with said anchors of said latch member and for limiting said supporting bracket to move relative to said housing and for preventing said supporting bracket and said cartridge member from being disengaged from said housing.

6. The caulking gun as claimed in claim 5, wherein said housing includes a compartment formed therein and communicating with said channel of said housing for selectively receiving and engaging with said projections of said supporting bracket.

7. The caulking gun as claimed in claim 3, wherein said latch device includes a spring biasing member engaged with said latch member for biasing and forcing said anchors of said latch member engage into said channel of said housing.

8. The caulking gun as claimed in claim 1, wherein said cartridge member includes a panel provided thereon for engaging with said supporting bracket.

9. The caulking gun as claimed in claim 1, wherein said cartridge member includes two casings for receiving a fluid to be dispensed.

10. The caulking gun as claimed in claim 9, wherein said casings of said cartridge member include a shape identical to each other.

11. The caulking gun as claimed in claim 9, wherein said casings of said cartridge member include a shape different from each other.

12. The caulking gun as claimed in claim 9, wherein said housing includes a driving device having two ram rods slidably engaged in said housing and slidably engaged into said casings of said cartridge member for selectively dispensing said fluid.

13. The caulking gun as claimed in claim 12, wherein said driving device includes a transfer block, said ram rods are attached to said transfer block and parallel to each other.

14. The caulking gun as claimed in claim 1 further comprising a spare supporting bracket engageable into said channel of said housing and including an opening formed in said spare supporting bracket, and a spare cartridge member engageable into said opening of said spare supporting bracket and detachably attached to said spare supporting bracket.

15. The caulking gun as claimed in claim 14, wherein said spare cartridge member includes a panel provided thereon for engaging with said spare supporting bracket.

16. The caulking gun as claimed in claim 14, wherein said spare cartridge member includes two casings for receiving a fluid to be dispensed.

17. The caulking gun as claimed in claim 14, wherein said casings of said spare cartridge member include a shape identical to each other.

18. The caulking gun as claimed in claim 14, wherein said casings of said spare cartridge member include a shape different from each other.
